(19) United States
(12) Patent Application Publication
(10) Pub. No.: US 2024/0397586 A1
(43) Pub. Date: Nov. 28, 2024

(54) BRACKET UNIT FOR UNDER INDUCTION RANGE AND UPPER PLATE ASSEMBLY HAVING THE SAME

(71) Applicant: PEACEWORLD CO., LTD, Gyeonggi-do (KR)

(72) Inventors: Myung Ock LEE, Gyeonggi-do (KR); Sang Woo KIM, Gyeonggi-do (KR)

(21) Appl. No.: 18/669,562

(22) Filed: May 21, 2024

(30) Foreign Application Priority Data
May 22, 2023 (KR) 10-2023-0065628

(51) Int. Cl. H05B 6/12; F24C 15/10

(52) U.S. Cl. CPC H05B 6/1209; F24C 15/10

(57) ABSTRACT

Provided is a bracket unit for installing an under induction range. The bracket unit comprises a main body; a first adhesion surface portion formed on a lower surface of the main body, wherein a first adhesive is applied to the first adhesion surface portion; a second adhesion protrusion protruding from the lower surface of the main body and having a height from the first adhesion surface portion, wherein the second adhesion surface portion onto which a second adhesive is applied is formed in parallel with the first adhesion surface portion; and a cover portion coupled to an upper surface of the main body and configured to mount the under induction range thereon to be installed to an object to be fixed.

### CROSS-REFERENCE TO RELATED APPLICATION

This application claims priority to and the benefit of Korean Patent Application No. 10-2023-0065628, filed on May 22, 2023, the disclosure of which is incorporated herein by reference in its entirety.

### BACKGROUND

### Technical Field

The present invention relates to an under-induction range, and more specifically, to a bracket unit for installing an under-induction range on the lower surface of a top plate and a top plate assembly including the same.

### Background Art

As a heating device for cooking food, microwave ovens, gas stoves, ovens, and the like have been used. However, use of induction ranges has been increasing in recent years due to problems, such as indoor air pollution and increased indoor temperature. An induction range is a heating cooking device which adopts an induction heating method and has considerable advantages in terms of high energy efficiency and stability. Moreover, the induction range possesses advantages in that the induction range does not consume oxygen and emit waste gas.

Generally, an induction range is installed with its top surface exposed through a top plate of a table. On the other hand, an under induction range refers to an induction range placed in the lower space of the top plate. The under induction range has a structure in which the upper portion of the under induction range is fixedly installed on the lower surface of the top plate.

The conventional installation technology for an under induction range involves a method of installing the under induction range to a top plate made of wood material using a fixed frame, screws, and the like, which requires work by a skilled worker. However, due to the characteristics of the under induction range, the top plate on which the under induction range is installed may be made of various materials, such as wood, marble, ceramic, glass, and the like. Accordingly, when the top plate is made of a material, such as marble, there is a problem in that the conventional technology may not be applied.

Also, the existing installation method by skilled workers has a problem of causing high costs due to increase in labor costs. In addition, inconvenience in installation creates a problem of limiting widespread distribution of the under induction range system.

### SUMMARY

### Technical Problem

Embodiments of the present invention have been invented to solve the problems described above and are aimed to provide a bracket unit which can simply and rapidly install an under induction range on a lower surface of a top plate of a table. More specifically, it is an object of the present invention to provide a bracket unit which anyone can simply and quickly install, regardless of the material of the top plate or the skill of an worker.

Also, the present invention is to provide a bracket unit that can improve installation stability, quality reliability, and the like.

Also, embodiments of the present invention aim to prevent the under induction range from being separated due to a user's mistake and damage resulting therefrom, after installation. In addition, embodiments of the present invention aim to enable simple and quick disassembly of the under induction range even after installation.

In addition, the present invention is to provide a top plate assembly which allows an under induction range to be simply and quickly installed into a top plate of a table.

### Technical Solution

To resolve the issues described above, embodiments of the present invention provide a bracket unit for installing an under induction range, comprising a main body; a first adhesion surface portion formed on a lower surface of the main body, wherein a first adhesive is applied to the first adhesion surface portion; a second adhesion protrusion protruding from the lower surface of the main body and having a height from the first adhesion surface portion, wherein the second adhesion surface portion onto which a second adhesive is applied is formed in parallel with the first adhesion surface portion; and a cover portion coupled to an upper surface of the main body and configured to mount the under induction range thereon to be installed to an object to be fixed.

A penetration prevention wall may be formed on the lower surface of the main body, and the penetration prevention wall prevents the first adhesive from deviating from the lower surface of the main body and moving to the object to be fixed when the first adhesive is spread by pressing.

It is preferable that a hardening time of the first adhesive is greater than a hardening time of the second adhesive, and when the first adhesive is hardened, the first adhesive partially absorbs an external shock or vibration to continue to provide an adhesive force.

It is preferable that upper surfaces of the penetration prevention wall and the second adhesion protrusion have a same height.

It is preferable that a first fastening portion is formed on the upper surface of the main body, wherein the first fastening portion is configured to vertically communicate with the second adhesion protrusion such that the main body is coupled to the object to be fixed only using a preset fastening member.

It is preferable that a second fastening portion is formed on the upper surface of the main body, wherein the second fastening portion protrudes in a height direction and has a threaded hole having a threaded structure on an upper inner circumference thereof.

It is preferable that the second adhesion protrusion further includes an expansion protrusion extending from the second adhesion protrusion in an outer direction of the main body to additionally improve a load bearing capacity of the main body with respect to the object to be fixed.

To resolve the issues described above, embodiments of the present invention provide a top plate assembly for installing an under induction range, comprising a top plate; a pair of bracket units for installing an under induction range according to claims 1 to 8, wherein the pair of the bracket units are coupled in a diagonal direction in the lower surface of the top plate.

### BRIEF DESCRIPTION OF THE DRAWINGS

FIG. 1 is a view illustrating a top plate provided with a main body of a bracket unit according to an embodiment of the present invention.

FIG. 2 is a perspective view of the main body of FIG. 1.

FIG. 3 is a plan view of FIG. 2.

FIG. 4 is an example view showing a state in which a first adhesive and a second adhesive are applied to the main body of FIG. 3.

FIG. 5 is a perspective view of FIG. 2, viewed from another direction.

FIG. 6 is a perspective view of a cover portion of the bracket unit according to an embodiment of FIG. 1.

FIG. 7 is a view showing an under induction range installed according to an embodiment.

FIG. 8 is a partial enlarged view of FIG. 7, viewed from another direction.

FIG. 9 is a side view showing an installation state of FIG. 7.

### DETAILED DESCRIPTION

Preferred embodiments of the present disclosure are described with reference to the appended drawings to enable a sufficient understanding about elements and effects of the present disclosure. However, the present disclosure is not limited to the disclosed embodiments below. Various forms may be obtained, and various modifications can be applied. Below, in describing the present invention, explanation on related known functions may be omitted if it is determined that the known functions are well-known to one having ordinary skill in the art and may obscure essence of the present invention.

Terms, such as “first,” “second,” etc., may be used herein to describe various elements. However, the elements should not be understood as being limited by these terms. These terms may be only used in distinguishing one element from another. For example, a first element may be referred to as a second element, and, similarly, a second element may be referred to as a first element, without departing from the scope of the present disclosure.

Herein, terms, such as “comprise,” “have,” etc., are designed to indicate features, numbers, steps, operations, elements, components, or a combination thereof are present. It should be understood that presence of one or more other features, numbers, steps, operations, elements, components, or a combination thereof or a possibility of addition thereof are not excluded.

Terms used herein are only to explain certain embodiments but not to limit the present invention. A singular expression may include a plural expression unless a clearly different meaning can be grasped from the context. Unless defined differently, terms used in embodiments of the present disclosure may be interpreted as generally known terms to one having ordinary skill in the art.

Specific embodiments of the present invention are described in detail with reference to the drawings.

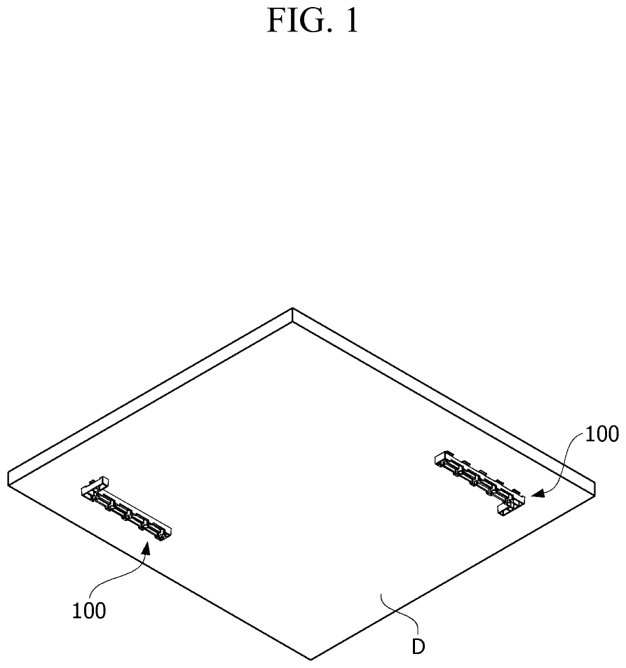

FIG. 1 is a view illustrating a top plate provided with a main body of a bracket unit according to an embodiment of the present invention. Referring to FIG. 1, a main body 100 according to an embodiment of the present invention may be installed on a top plate D, in particular on the lower surface of the top plate D. The top plate D refers to an object to which an under induction range I is fixedly installed. The top plate D may refer to a top portion of a dining table used at home or in a restaurant, etc. Also, the top plate D may refer to a top portion such as of a sink if cooking is possible thereon. The top plate D may be formed of any material selected from a group of non-magnetic materials, such as marble or glass, as well as wood. In one embodiment, the upper and lower surfaces of the top plate D are flatly formed, and the top plate D preferably has a thickness within a preset range. The thickness range of the top plate D may change depending on the material of the top plate D.

An induction range is a cooking device that heats food or the like in a container to be heated using an indirect method where heat is induced in the container itself using a magnetic field. In general, the induction range is installed as a structure where the upper surface of the induction range is exposed through the top plate D. On the other hand, the under induction range I refers to an induction range placed on the lower side of the top plate D. As a result, the magnetic field generated by a circular coil in the under induction range I passes through the top plate D and heats the container to be heated, positioned on top of the top plate D. The under induction range I according to one embodiment may be fixedly installed while the top surface thereof closely contacts with the lower surface of the top plate (the object to which the under induction range I is fixed) or while the top surface thereof is spaced a distance apart from the lower surface of the top plate (the object to which the under induction range I is fixed).

In one embodiment, the main body 100 may be fixedly coupled to the lower surface of the top plate D. To this end, a first fastening portion 130 may be formed in the main body 100, which is used when the main body 100 may be easily assembled and fixed to the top plate D by a fastening member (a screw or the like) as the top plate D is made of a material, such as wood.

In addition, in an embodiment, a first adhesion surface portion 110 and a second adhesion protrusion 120 may be formed on the main body 100, which is used as another coupling means such as when the main body 100 may not be assembled and fixed to the top plate D by a fastening member (a screw or the like) since the top plate D is made of a material, such as marble, glass and the like.

In other words, the main body 100 according to one embodiment allows the under induction range I to be easily fixed and installed to the top plate D, regardless of the material of the top plate D. In one embodiment, two main bodies 100 are arranged such that each main body 100 is in a diagonal direction. In one embodiment, the main body 100 is coupled to the lower surface of the top plate D by a first adhesive (a1) and a second adhesive (a2).

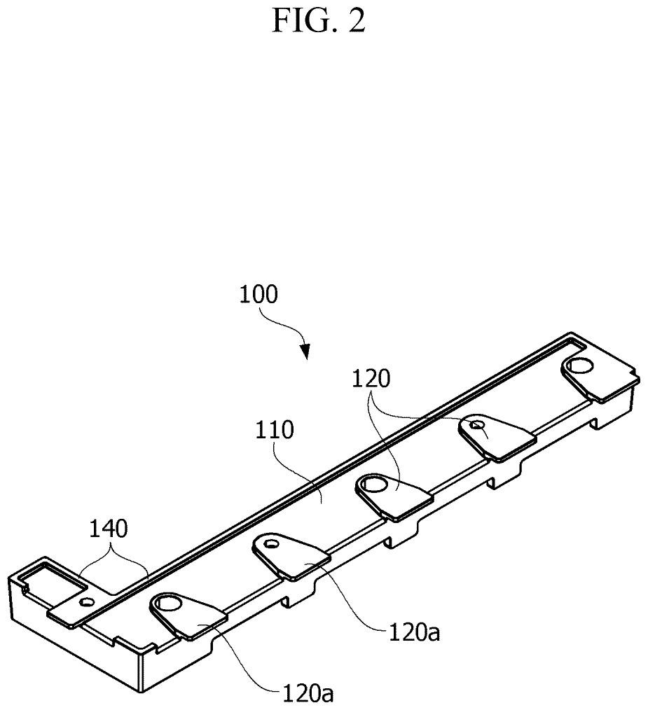

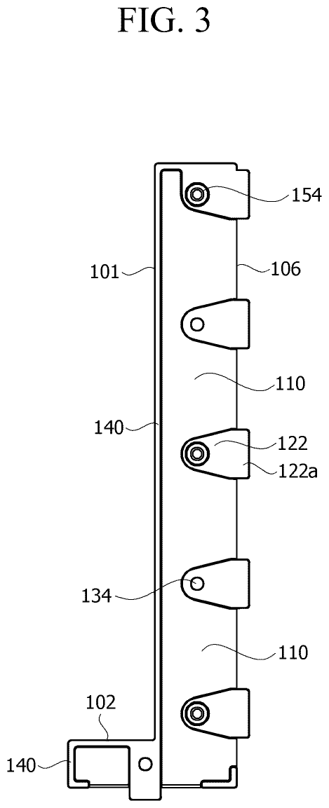

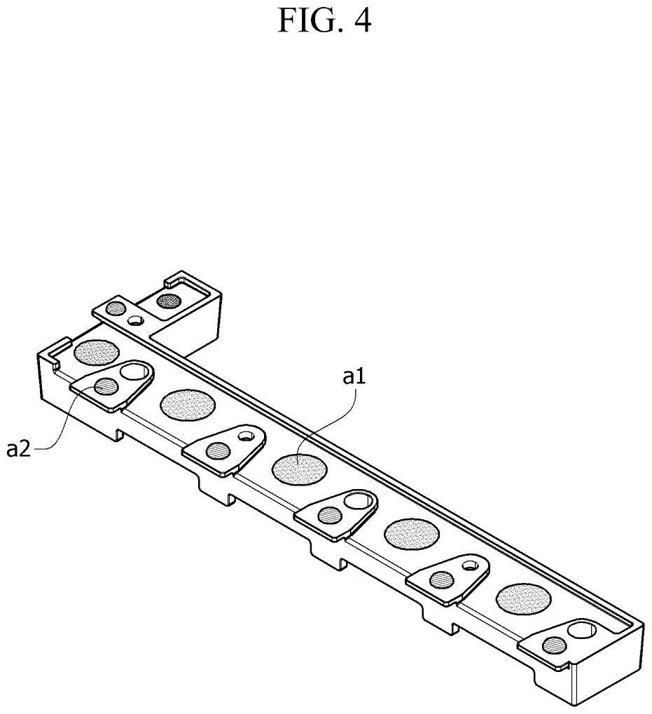

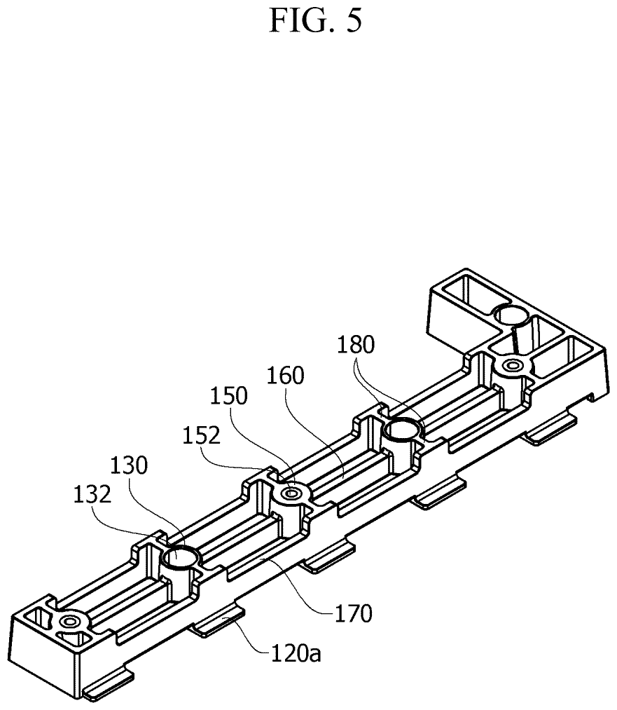

FIG. 2 is a perspective view of the main body of FIG. 1, FIG. 3 is a plan view of FIG. 2, and FIG. 4 is an example view showing a state in which the first adhesive and the second adhesive are applied to the main body of FIG. 3. Also, FIG. 5 is a perspective view of FIG. 2 viewed from another direction.

The upper portion of the under induction range I according to one embodiment has all four corners formed at right angles. In addition, in one embodiment, the main body 100 may be formed as one piece using a manufacturing method, such as injection molding.

Referring to FIGS. 2 to 5, the main body 100 according to one embodiment is preferably formed as an overall ‘L’ shape to correspond to each corner of the under induction range I. Through this, the under induction range I may be stably fixed and coupled to any location on the top plate (the object to which the under induction range I is fixed).

In one embodiment, the main body 100 may include an inner surface which contacts each of any upper corner of the under induction range I and an adjacent surface to the upper corner of the under induction range I. At this time, the inner surface of the main body 100 is preferably formed as a flat surface to be closely coupled to the top portion of the under induction range I.

Specifically, the inner surface of the main body 100 may be provided with a vertical inner surface 101 closely coupled to the upper outer surface of the under induction range and a horizontal inner surface 102 being perpendicular to the vertical inner surface 101 to be closely coupled to the upper outer surface of the under induction range I. Also, the main body 100 includes an outer surface 106 formed parallel to the inner surface.

In one embodiment, the main body 100 may include the first adhesion surface portion 110 formed on the lower surface of the main body 100. The first adhesive (a1) is applied to the first adhesion surface portion 110. In an embodiment, the lower surface of the main body 100 may be only formed of a flat surface without steps. The first adhesion surface portion 110 may correspond with the lower surface of the main body 100. Alternatively, the first adhesion surface portion 110 may be a part of the lower surface of the main body 100. At this time, the first adhesive (a1) may be applied to a plurality of locations in the first adhesion surface portion 110.

In one embodiment, the first adhesive (a1) may be an adhesive which hardens within 12 to 36 hours after application, being relatively slow but strong providing adhesive strength. In other words, the first adhesive (a1) takes longer to cure than the second adhesive (a2), which will be described later. The first adhesive (a1) may be, for example, a silicone adhesive. Providing elasticity when cured due to the material characteristic, the silicone adhesive may absorb some of external shock, vibration and the like.

Additionally, the main body 100 may include the second adhesion protrusion 120 which protrudes from the lower surface of the main body 100 to have a height with respect to the first adhesion surface portion 110. The second adhesion surface portion 110 parallel to the first adhesion surface portion 110 is formed so that the second adhesive (a2) is applied to the second adhesion protrusion 120. At this time, the second adhesion surface portion 122 may be the upper surface of the second adhesion protrusion 120.

The second adhesion protrusion 120 is configured so that the area of the second adhesion surface portion 122 increases from the inner side of the main body 100 toward the outer direction of the main body 100. Moreover, the second adhesion protrusion 120 protrudes vertically downward from the lower surface of the main body 100, i.e., in the thickness direction of the main body 100. A plurality of the second adhesion protrusions 120 which are spaced apart perpendicular to a direction in which the main body 100 extends. At this time, the second adhesive (a2) may be applied to all or part of the second adhesion surface portion 122. In one embodiment, the second adhesion protrusion 120 may have some differences in shape depending on its location.

In one embodiment, the second adhesive (a2) may be an adhesive that hardens within 5 to 20 minutes after application to provide rapid adhesion. The second adhesive (a2) may be, for example, an epoxy adhesive. The epoxy adhesive may be used after a base material and a hardener are mixed in a preset mixing ratio.

As such, the main body 100 according to one embodiment may be quickly, stably, and continuously coupled to the top plate D by the different adhesive properties provided by the first adhesive (a1) and the second adhesive (a2). At this time, it is preferable that the application amount of the first adhesive (a1) is greater than that of the second adhesive (a2). In consequence, even when an external shock is directly or indirectly exerted on the main body 100, etc., the main body 100 may be stably and fixedly coupled to the lower surface of the top plate D due to the first adhesive (a1).

Moreover, in one embodiment, the second adhesive protrusion 120 may include an expansion protrusion 120a which extends from the second adhesive protrusion 120 in the outer direction of the main body 100 to further improve the load bearing capacity of the main body 100 with respect to the object to which the under induction range I is to be fixed. At this time, the expansion protrusion 120a is formed on a same plane as the second adhesive surface portion 122 and includes an expanded adhesion surface portion 122a to which the second adhesive (a2) can be applied.

Thus, the second adhesive (a2) may be directly applied to all or part of the expanded adhesion surface portion 122a. On the other hand, the second adhesive (a2) applied to the second adhesion surface portion 122 may be spread by pressure to be applied to all or part of the expanded adhesion surface portion 122a. As a result, the expanded adhesion surface portion 122a may further improve the adhesion strength by the second adhesive (a2).

In one embodiment, a penetration prevention wall 140 may be formed at the lower surface of the main body 100. The penetration prevention wall 140 may prevent the first adhesive (a1) spreading by the pressing from deviating from the lower surface of the main body 100 toward the object to be fixed. In an embodiment, it is preferable that the penetration prevention wall 140 protrudes upward while having a certain width and is formed in the lower surface of the main body 100, in particular, along an inner periphery of the main body 100.

While the main body 100 is fixedly coupled to the lower surface of the upper plate D, the first adhesive (a1) may be pressed by the top plate D. The penetration prevention wall 140 may prevent the first adhesive (a1) from moving in the inner direction of the main body 100 and deviating from the lower surface of the main body 100 when the first adhesive (1) applied to the first adhesion surface portion 110 is pressed. This may prevent the first adhesive (a1) from contacting the under induction range I during the process of installing the under induction range I on the top plate D.

Furthermore, in one embodiment, it is preferable that the upper surfaces of the penetration prevention wall 140 and the second adhesion protrusion 120 have the same height. This allows the main body 100 to be coupled in parallel with the top plate D. Also, this can improve the coupling force of the main body 100 to the top plate D. In another embodiment, it is preferable that the upper surfaces of the penetration prevention wall 140, the second adhesive protrusion 120, and the expansion protrusion 120a have the same height.

Referring to FIG. 5, in one embodiment, the first fastening portion 130 is formed at the upper surface of the main body 100. The first fastening portion 130 communicates with the second adhesion protrusion 120 in the vertical direction to couple the main body 100 to the object to be fixed only using a preset fastening member.

In one embodiment, the first fastening portion 130 may protrude upward from the upper surface of the main body 100. Specifically, the first fastening portion 130 may include a fastening groove 132, a fastening hole 134, and the like. The fastening groove 132 has an open upper portion to provide a space to receive and couple a fastening member inserted through the upper portion. Additionally, the fastening hole 134 communicates with the second adhesion surface portion 122 and allows the threaded portion of the fastening member to pass through. Here, the fastening member may be, for example, a screw. As a result, the main body 100 may be coupled to the object to be fixed even without using the above-described first adhesive (a1) and second adhesive (a2).

Additionally, in one embodiment, a second fastening portion 150 protruding in a height direction may be formed on the upper surface of the main body 100 and has a threaded hole 152 with a thread structure on the upper inner peripheral surface. Besides, the second fastening portion 150 may include a receiving groove 154 which communicates with the second adhesion surface portion 122.

In one embodiment, a cover portion 200 may be coupled to the main body 100 by a fastening member, such as a bolt (b). In other words, the receiving groove 154 provides a space in which the fastening member passing through the threaded hole 152 is accommodated when the cover portion 200 is coupled to the main body 100. Also, the receiving groove 154 may accommodate the second adhesive a2 which is partially moved in the inner direction of the main body 100 when the second adhesive a2 is spread by the pressing.

At this time, it is preferable that the first fastening portion 130 and the second fastening portion 150 are alternately arranged with each other. Additionally, the first fastening portion 130 and the second fastening portion 150 preferably have the same height.

Meanwhile, a contact rip portion 180 may formed on the upper surface of the main body 100. The contact rip portion 180 may have the same height as the first fastening portion 130 and the second fastening portion 150 and make a surface-contact with the lower surface of the cover portion 200. The contact rib portion 180 may increase the coupling force between the main body 100 and the cover portion 200.

Additionally, a periphery rib portion 170 protruding from a portion of the periphery of the upper surface of the main body 100 by a preset height may be formed on the upper surface of the main body 100 according to one embodiment. The periphery rib portion 170 may prevent deformation or damage of the main body 100.

Moreover, an inner rib portion 160 protruding from the upper surface of the main body 100 according to an embodiment with a preset height and connecting between the first fastening portion 130 and the second fastening portion 150 may be provided. The inner rib portion 160 may increase the rigidity of the first fastening portion 130 and the second fastening portion 150.

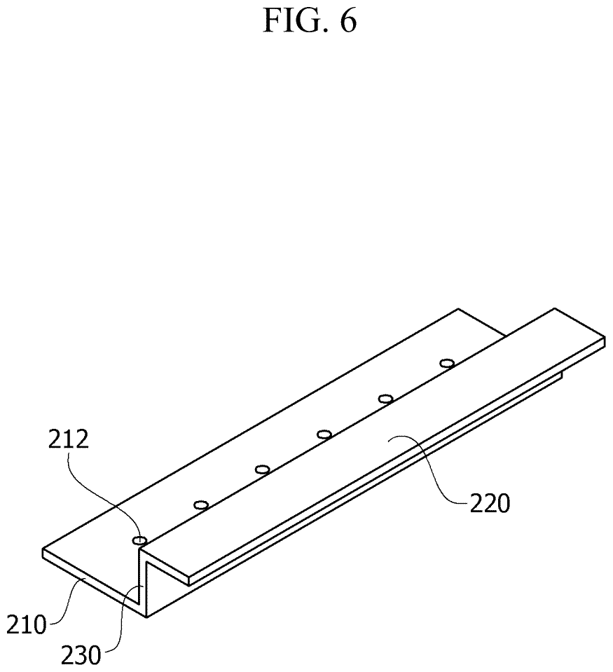

FIG. 6 is a perspective view of the cover portion of the bracket unit according to an embodiment of FIG. 1. Referring to FIG. 6, the bracket unit for installing the under induction range I according to one embodiment is coupled to the upper surface of the main body 100 and may further include the cover portion 200 that mounts the under-induction range I thereon to install the under induction range I to the object to be fixed.

Specifically, the cover portion 200 may include a cover plate 210, a connection plate 230, a mounting plate 220, and the like. The cover plate 210 corresponds to a cover which covers at least a portion of the upper surface of the main body 100 when the cover portion 200 is coupled to the main body 100. At this time, at least one or more through holes 212 are spaced apart with each other in the cover plate 210. The mounting plate 220 has a height from the cover plate 210 and provides a mounting portion on which the under induction range I is mounted. The connection plate 230 connects between the cover plate 210 and the mounting plate 220.

In order to couple the cover portion 200 to the main body 100, the cover portion 200 is first placed on the upper surface of the main body 100 so that the through hole 212 and the threaded hole 152 vertically communicate with each other. Then using a fastening member, such as the bolt (b), the bolt (b) is passed through the through hole 212 and the threaded hole 152 and is fastened to the main body 100.

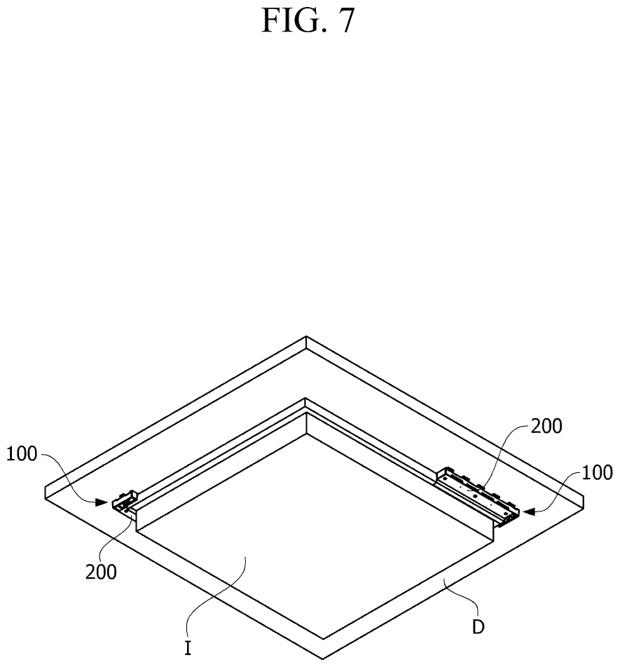

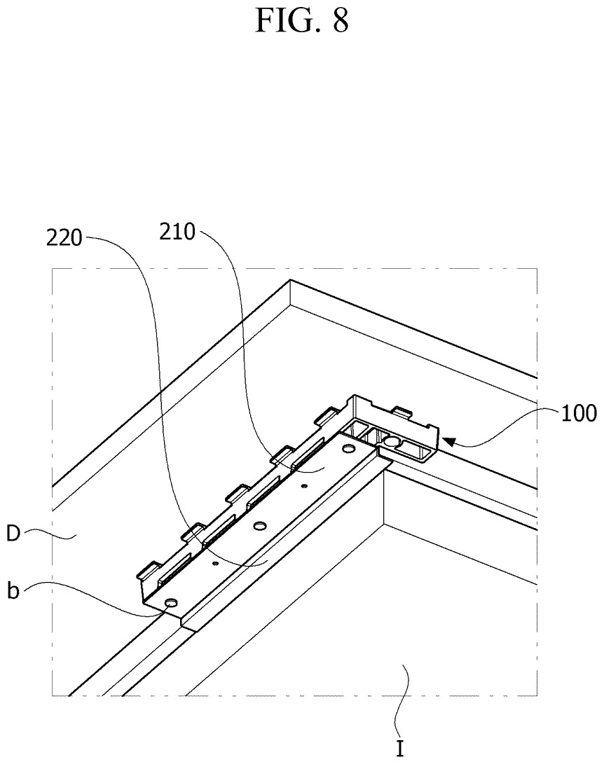

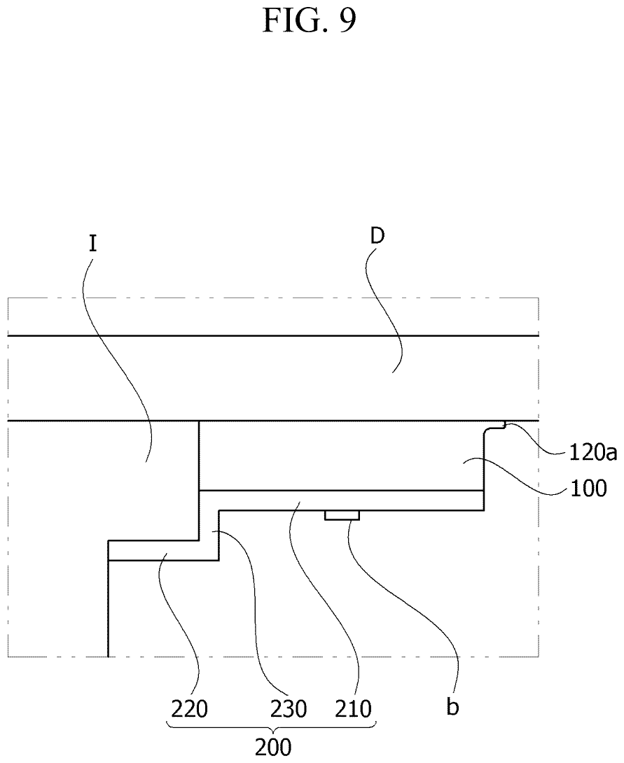

FIG. 7 is a view showing an under induction range installed according to an embodiment, FIG. 8 is a partial enlarged view of FIG. 7, viewed from another direction, and FIG. 9 is a side view showing an installation state of FIG. 7. Referring to FIGS. 7 to 9, in one embodiment, the upper surface of the under induction range I faces the lower surface of the top plate D and then are coupled in contact with each other.

To this end, a top plate assembly to which a pair of the bracket main body 100 is coupled in any one diagonal direction is prepared as in FIG. 1. Also, the under induction range I is aligned on the lower surface of the top plate D, corresponding to each position of the main body 100. At this time, the lower surface of the top plate D and the upper surface of the under induction range I are in close contact with each other. Next, the under induction range (I) is mounted using the cover portion 200. At this time, the under induction range I is mounted at one side of the cover portion 200, and the cover plate 210 is fixedly coupled to the main body 100 using the bolts b at the other side of the cover portion 200. As a result, the under induction range I may be simply and rapidly installed at the lower side of the top plate D.

A top plate assembly for installing an under induction range I according to an embodiment of the present invention may include the top plate D and the bracket unit. Here, the top plate D corresponds to the object to be fixed. As having been described in detail above, detailed description thereof will be omitted below.

In addition, since the bracket unit according to one embodiment has already been described in detail for installing the under induction range I, detailed description thereof will be omitted below. In one embodiment, a pair of the bracket units, i.e., two bracket units, may be coupled in a diagonal direction of the lower surface of the top plate D. In contrast, a total of four bracket units may be combined on the lower surface of the top plate D in diagonal directions that intersect each other.

According to the technical solutions of the present invention as described above, various effects including the following may be anticipated. However, the present invention does not require all of the following effects to be achieved.

According to embodiments of the present invention, an under induction range may be simply and rapidly installed on a lower surface of a top plate of a table. More specifically, an induction range may be simply and quickly installed by anyone, regardless of the material of the top plate or the skill level of a worker.

Also, installation stability and quality reliability may be improved.

Also, embodiments of the present invention may prevent the under induction range from being separated due to a user's mistake and resulting damage after installation. In addition, even after installation work, the under induction range can be easily and quickly removed.

In the above, preferred embodiments of the present invention have been described by way of examples, but the scope of the present invention is not limited to these specific embodiments and may be appropriately modified within the scope recited in the claims.

What is claimed is:

1. A bracket unit for installing an under induction range, comprising:
a main body;
a first adhesion surface portion formed on a lower surface of the main body, wherein a first adhesive is applied to the first adhesion surface portion;
a second adhesion protrusion protruding from the lower surface of the main body and having a height from the first adhesion surface portion, wherein a second adhesion surface portion onto which a second adhesive is applied is formed in parallel with the first adhesion surface portion; and
a cover portion coupled to an upper surface of the main body and configured to mount the under induction range thereon to be installed to an object to be fixed.

2. The bracket unit for installing an under induction range of claim 1, wherein a penetration prevention wall is formed on the lower surface of the main body, and the penetration prevention wall prevents the first adhesive from deviating from the lower surface of the main body and moving to the object to be fixed when the first adhesive is spread by pressing.

3. The bracket unit for installing an under induction range of claim 1, wherein a hardening time of the first adhesive is greater than a hardening time of the second adhesive, and
when the first adhesive is hardened, the first adhesive partially absorbs an external shock or vibration to continue to provide an adhesive force.

4. The bracket unit for installing an under induction range of claim 2, wherein upper surfaces of the penetration prevention wall and the second adhesion protrusion have a same height.

5. The bracket unit for installing an under induction range of claim 1, wherein a first fastening portion is formed on the upper surface of the main body, wherein the first fastening portion is configured to vertically communicate with the second adhesion protrusion such that the main body is coupled to the object to be fixed only using a preset fastening member.

6. The bracket unit for installing an under induction range of claim 1, wherein a second fastening portion is formed on the upper surface of the main body, wherein the second fastening portion protrudes in a height direction and has a threaded hole having a threaded structure on an upper inner circumference thereof.

7. The bracket unit for installing an under induction range of claim 1, wherein the second adhesion protrusion further includes an expansion protrusion extending from the second adhesion protrusion in an outer direction of the main body to additionally improve a load bearing capacity of the main body with respect to the object to be fixed.

8. A top plate assembly for installing an under induction range, comprising:
a top plate; and
a pair of bracket units for installing an under induction range according to claim 1,
wherein the pair of the bracket units are coupled in a diagonal direction in the lower surface of the top plate.
